(19) United States
(12) Patent Application Publication
(10) Pub. No.: US 2010/0011066 A1
(43) Pub. Date: Jan. 14, 2010

(54) CONTROLLING EMAIL DISTRIBUTION LISTS USING POLICIES

(75) Inventors: LI CHEN, CARY, NC (US); JOHN R. HIND, RALEIGH, NC (US); YONGCHENG LI, CARY, NC (US); LUN XIAO, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/169,758

(22) Filed: Jul. 9, 2008

(51) Int. Cl. G06F 15/16

(52) U.S. Cl. 709/206

(57) ABSTRACT

A policy can be established that is associated with an email distribution list. The policy can specify an extent that email addresses contained in the email distribution list are visible to recipients. An email message to be conveyed to at least the email distribution list can be identified. A set of recipient messages can be created from the identified email message—one recipient message for each of the recipients. The policy can be applied to each recipient message to determine an extent that email addresses contained in the email distribution list are visible to that recipient. Different ones of the recipient email messages can have different visibility regarding email addresses of members of the distribution list based upon the applied policy.

### BACKGROUND OF THE INVENTION

The present invention relates to the field of electronic mail and, more particularly, to controlling email distribution lists using policies.

Email distribution lists are an invaluable tool for users who often manage large groups of email addresses. Distribution lists offer an efficient and effective means to sort recipients into logical groupings as necessary. While distribution lists are useful, several disadvantages arise through their usage. One problem arises from the manner in which email clients present distribution lists, showing all the recipients of an email. Though very useful for allowing recipients to reply easily, the addresses are exposed in an uncontrolled fashion once an email is sent.

For example, when an email with a distribution list is forwarded, the recipient of the forwarded email can obtain distribution list addresses. Further, if a recipient replies to an email and includes a non-authorized recipient, the non-authorized recipient can obtain precious list information and addresses. For instance, marketing distribution lists are very valuable to businesses and dissemination of address information to unauthorized parties can be extremely detrimental. Currently there are no solutions which sufficiently address these problems.

### BRIEF DESCRIPTION OF THE SEVERAL VIEWS OF THE DRAWINGS

FIG. 1 is a schematic diagram illustrating a scenario for controlling an email distribution list using user established policies in accordance with an embodiment of the inventive arrangements disclosed herein.

FIG. 2 is a schematic diagram illustrating a system for email distribution lists controlled by user defined policies in accordance with an embodiment of the inventive arrangements disclosed herein.

FIG. 3 is a schematic diagram illustrating a process for creating a customized distribution list in accordance with an embodiment of the inventive arrangements disclosed herein.

FIG. 4 is a schematic diagram illustrating a set of interfaces for applying policies to distribution lists in accordance with an embodiment of the inventive arrangements disclosed herein.

### DETAILED DESCRIPTION OF THE INVENTION

The present invention discloses a solution for utilizing policies for email distribution lists to control the dissemination of address information. In the solution, each distribution list is associated with an owner, who can establish a policy for each list. The policy can vary exposure and handling of the distribution list based on recipient. As such, a set of recipients receiving a common email message can have variable exposure to a distribution list. The policy controls can be applied to any email message that has a distribution list associated with the email message which can include response messages and messages resulting from the initial sending. Based on the owner established policies, suitable settings can be assigned to the distribution list. Policy settings can be arbitrarily complex, which can include recipient specific handling, message specific handling, context specific handling, and combinations thereof.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

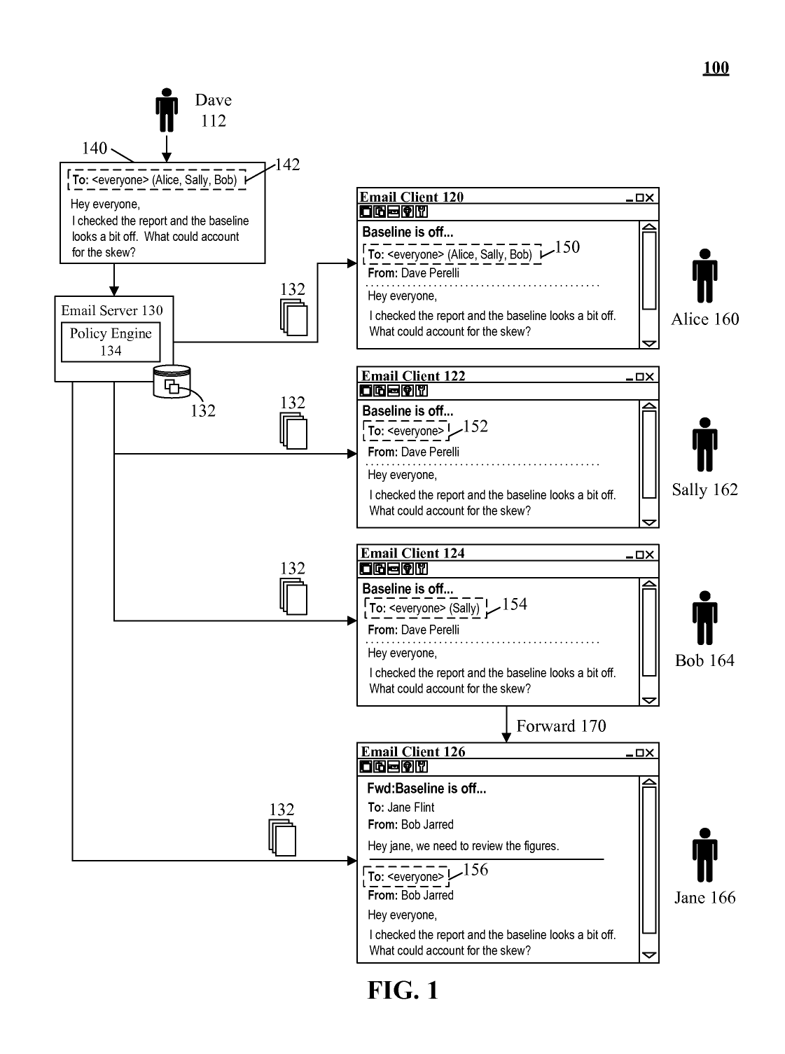

FIG. 1 is a schematic diagram illustrating a scenario 100 for controlling an email distribution list using user established policies in accordance with an embodiment of the inventive arrangements disclosed herein. In scenario 100, a user established policy 132 for an email distribution list 142 can be used to control recipient information after transmission of an email message 140. User 112 composing an email message 140 can assign a private distribution list (e.g., address book group) 142 to message 140. The distribution list can be associated with a policy 132 which can control presentation of the user assigned distribution list. Email server 130 can convey message 140 to users 160-164. Distribution lists 150-154 of conveyed messages can be presented based on policy 132 information. During email presentation, policy information 132 can be conveyed to email clients 120-124. Policy 132 information can be processed and policy defined presentation of distribution lists 150-154 can be performed. For example, a distribution list 142 policy owned by Dave 112 can be used to show all recipients to Alice 160 while hiding recipients from being presented to Sally 162 and Bob 164.

In the scenario, policy 132 can be stored in association with an email server 130 able to process and convey policy 132. Email server 130 can comprise of a policy engine 134 which can process policy requests from email clients 120-126. Policy 132 requests can occur when a user accesses an email containing a distribution list 142 with an associated policy. As shown herein, distribution list 142 can include recipient name and/or email address information which can be hidden or visible based on configuration established by policy 132.

Policy 132 can be used to control recipient information after the initial email 140 delivery. Policy settings can be established for each recipient in the distribution list 142. The corresponding setting can be used to determine the manner in which list 142 is presented to the user. For instance, when visibility is enabled for Alice 160, Alice 160 can see the distribution list name and/or all the recipients in the list 142, as shown in list 150. In a situation where a recipient 162 is not authorized to view recipients, the distribution list name can be shown.

Further, policy 132 can be used to maintain recipient information dissemination independently of further email transmissions. Policy 132 can be used to restrict reply-all functionality. As such, users can only reply to the original author of the email 140 and only recipients which are visible in the list 142. For example, Bob 164 cannot see Alice in the list 154 and as such can only reply to Sally 162. Policy 132 can also be employed to control recipient information from being divulged. For instance, after receiving email 140 from Dave 112, Bob 164 can forward email 140 to Jane 166. Email client 126 can request policy 132 information for distribution list 156. Policy 132 can be conveyed to email client 126 which can present distribution list 156 according to policy 132 configuration.

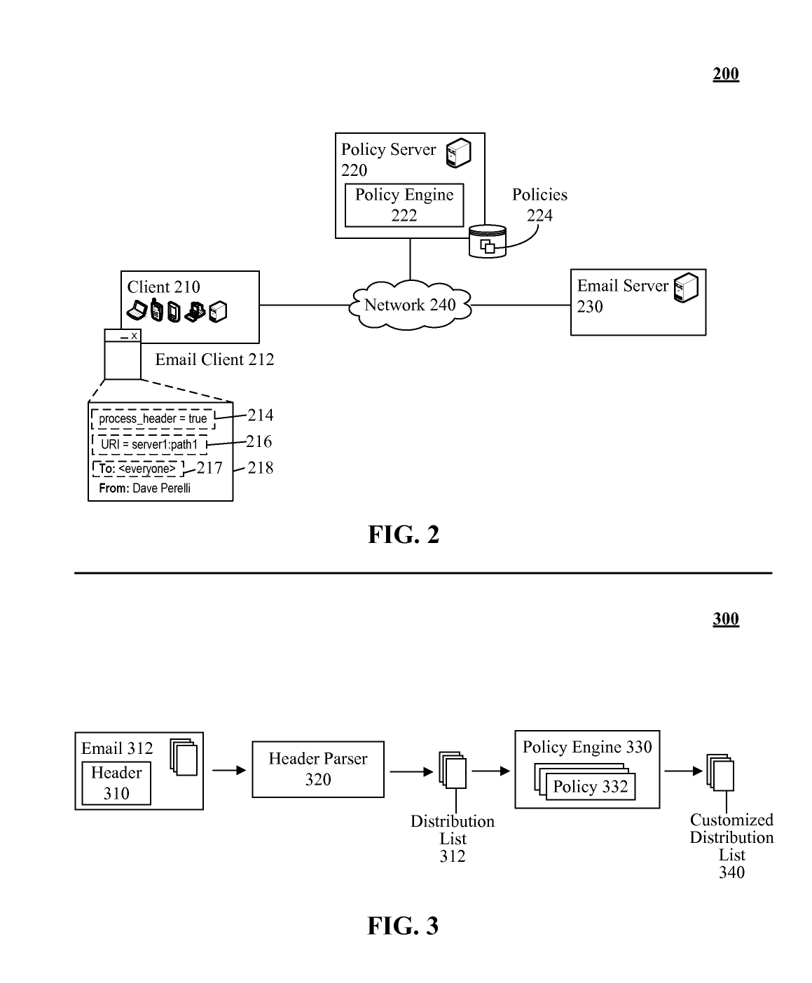

FIG. 2 is a schematic diagram illustrating a system 200 for email distribution lists controlled by user defined policies in accordance with an embodiment of the inventive arrangements disclosed herein. System 200 can facilitate activities performed in scenario 100. In system 200, a policy server 220 can enable an owner of a distribution list 217 to control the presentation of list 217 using user defined policies 224. Email client 212 can permit the owner to compose an email 218 which can include header information 214, 216, and list 217. Information 214, 216 can enable policy engine 222 to apply appropriate distribution list restrictions to emails delivered by email server 230.

As used herein, policy 224 can be a set of user defined rules for presenting a recipient name and/or email address associated with a distribution list. In one embodiment, a policy 224 can also affect functionality related to a distribution list, such as an ability to reply to all members of a distribution list. Distribution list 217 can include one or more recipients. Presentation can include modifying the visibility of one or more recipients and recipient associated information. For instance, policy 224 can be used to present distribution lists in an expanded form (e.g., showing recipient names) or collapsed form showing only the distribution list 217 name. The policy 224 can be a stored locally on a client computing device or can be stored remotely on a server computing device.

In system 200, policy server 220 can be communicatively linked to one or more client 210 computing devices. The clients 210 can include email client 212 able to process policy 224. The clients 210 can be communicatively linked to one or more policy servers 220 and email servers 230. The server 220 provides a means to manage and store policy 224 associated with user created email distribution lists.

Although system 200 shows a role-based embodiment, other configurations are contemplated. In one embodiment, policy server 220 and policy engine 222 can be present in server 230. Further, in another embodiment, functionality attributed to the policy server 220 can be included in email server 230. Alternatively, policy server 220 functionality can be provided as a Web service that extends engine 222 functionality. Additionally, servers 220, 230 can be implemented as a cluster of servers and/or a set of distributed computing elements, real or virtual, that together provide functionality discussed for servers 220, 230.

When a distribution list 218 is assigned, client 210 can request policy 224 information for the specified distribution list. Policy 224 information, such as policy location 216, can be conveyed across network 240 to client 210. Policy 224 can be processed by email client 210 and header information 214, 216 can be appended to email 218. Information 214, 216 can be utilized by policy aware email clients to present distribution lists as intended by the list owner. For instance, information 214 “process_header=true” can be used by an owner to impose mandatory policy rules on a distribution list. When information 214 is present, policy aware email clients can be required to request and parse policy 224.

In one embodiment, policy aware email clients can be a requirement to access “hidden” policy controlled functionality, such as an ability to selectively view distribution list membership. Standard email clients (not enhanced with policy awareness) can receive default information, where by default membership of controlled distribution lists can be redacted. Encryption technologies that require policy aware email clients to decrypt distribution list can be utilized to protect the policy controlled information.

In one embodiment, information 216 can be a URI addressable location for a policy for the distribution list associated with email 218. For instance, information 216 can specify a server address (e.g., server1) and a file system path (e.g., path1) where the policy can be located. Alternatively, information 216 can provide a URI addressable location where an email client can negotiate a policy request.

In one embodiment, policy engine 222 can append information 214, 216 prior to transmission to email server 230. Policy sever 220 can act as a proxy for client 210, applying policy specific header information to email 218 sent from client 210. Information 214, 216 is for illustrative purposes only and should not be construed to limit the invention in any regard. Although presented herein as plaintext header flags, information 214, 216 can include any binary coded information associated with an email.

FIG. 3 is a schematic diagram illustrating a process 300 for creating a customized distribution list in accordance with an embodiment of the inventive arrangements disclosed herein. Process 300 can be performed in the context of system 200. In process 300, a header 310 can be evaluated and a customized distribution list 340 can be obtained. Process 300 can occur within a client 210 computing device, policy server 220 and/or email server 230.

Header 310 from email 312 can be analyzed by header parser 320 to produce distribution list 312. Distribution list 312 can include one or more recipient names and/or email addresses. List 312 can be processed by policy engine 330 which can apply a user specified policy 332 to list 312. In one embodiment, policy 332 can only be used by the owner of list 312. Alternatively, a policy 332 can be shared among users, enabling non-owners to apply policy 332 to a distribution list. Engine 330 can produce customized list 340 which can be presented in a user controlled fashion.

Policy 332 can control the visibility of information for one or more recipients in list 340. Visibility can include hiding or showing recipient name and/or email addresses and can include list 340 expansion policies. For example, a customized list 340 can be configured to auto-expand by default, showing all recipients in list 340 that are not exclusively marked as hidden.

In one embodiment, policy 332 can be used to control list 340 operations such as inclusive filtering, exclusive filtering, and combinative addressing. For instance, policy 332 can permit or deny filtering a subset of recipients from list 340. Further, policy 332 can allow customized list 340 to be combined with another distribution list. In combinative addressing, conflicts can be resolved by assigning the lowest privilege to conflicting recipients. Further, settings can be established within policy 332 to handle multiple lists conditions. When more than one list is present special policy 332 rules can be applied to either or both lists. For example, when a “co-workers” and “family” distribution list is present, the policy 332 can be used to hide “coworkers” recipients from “family” recipients.

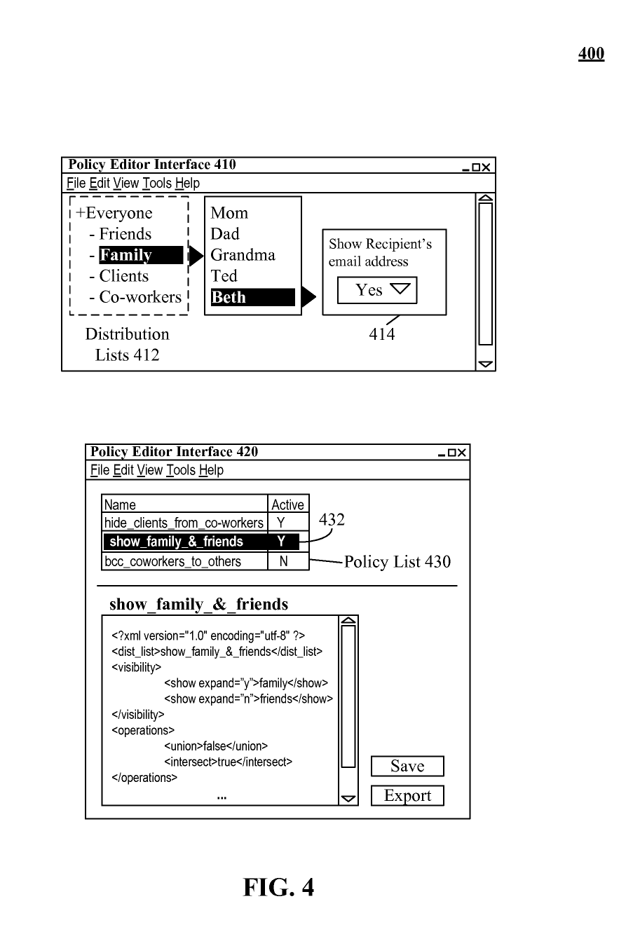

FIG. 4 is a schematic diagram illustrating a set of interfaces 410, 420 for applying policies to distribution lists in accordance with an embodiment of the inventive arrangements disclosed herein. Policy editor interface 410, 420 can be present in the context of system 200. Policy editor interface 410 can be used to configure the presentation of recipient information from a set of distribution lists 412. Policy editor interface 420 can be used to activate and modify policies associated with a distribution list.

In interface 410, a user can be presented with a set of distribution lists 412 owned by the user. Interface 410 can enable the user to configure the distribution list 412 and configure specific recipients belonging to the list. Individual recipient information visibility can be adjusted using interface 410. For example, a drop-down box can enable a user to toggle email name and/or address visibility for a recipient.

In interface 420, a set of user created policies accessible to the user can be presented as policy list 430. Activation of policies can be toggled based on user need and requirements. In one embodiment, policies can be an extensible markup language (XML) file able to be manually edited by a user. In interface 430, selected policy 432 code can be presented to the user. Alternatively, interface 430 can present a graphical user interface (GUI) artifact which can enable the user to configure policy ruleset.

The diagrams presented herein are for illustrative purposes only and should not be construed to limit the invention in any regard. Interfaces 410, 420 can be one of a set of interfaces associated with a policy editor and/or an email client. Interfaces 410, 420 can include a graphical user interface, voice user interface (VUI), multi-modal interface, and the like.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for policy controlling email distribution lists comprising:
establishing a policy associated with an email distribution list, wherein said policy specifies an extent that email addresses contained in the email distribution list are visible to recipients;
identifying an email message to be conveyed to at least the email distribution list, wherein the identified email message is to be conveyed to a plurality of recipients, wherein said plurality of recipients comprise a set of recipients associated with the email addresses contained in the email distribution list;
creating a plurality of recipient messages from the identified email message, one recipient message for each of the recipients; and
applying the policy to each recipient email message to determine an extent that email addresses contained in the email distribution list are visible to that recipient.

2. The method of claim 1, wherein different ones of the recipient email messages have different visibility regarding email addresses of members of the distribution list based upon the applied policy.

3. The method of claim 1, wherein said policy is associated with a policy owner who possesses authorization privileges to establish and modify said policy.

4. The method of claim 3, wherein a plurality of different policies exist, each having a policy specific owner, each being associated with a specific distribution list, and each being associated with a set of at least one recipients: said method further comprising:
determining the policy to be applied to each recipient email message based upon an identity of the distribution list and based upon an identity of the recipients.

5. The method of claim 1, further comprising:
identifying a response to one of recipient email message, where said response is to be conveyed to at least the email distribution list, wherein the response is to be conveyed to a plurality of response recipients, wherein said plurality of response recipients comprise a set of recipients associated with the email addresses contained in the email distribution list; and
creating a plurality of response recipient messages from the response, one response recipient message for each of the response recipients; and
applying the policy to each response recipient message to determine an extent that email addresses contained in the email distribution list are visible to that response recipient.

6. The method of claim 1, wherein the policy applied to each response recipient message was originally established by a sender of the identified email message.

7. The method of claim 1, wherein said policy is one of a plurality of established policies associated with email distribution list that is maintained within a network accessible data store, said method further comprising:
querying the data store for the policy to apply to each recipient, wherein said policy is one associated with the sender of the identified email message.

8. The method of claim 1, wherein the established policy is specified in a header of the identified email message, and wherein the header further comprises at least one visibility attribute.

9. The method of claim 1, wherein responses to said recipient email messages that include the email distribution list are only conveyed to those email addresses contained in the email distribution list are visible within the recipient email message from which the response was generated.

10. A computer program product for policy controlling email distribution lists comprising:
a computer usable medium having computer usable program code embodied therewith, the computer usable program code comprising:
computer usable program code configured to establish a policy associated with an email distribution list, wherein said policy specifies an extent that email addresses contained in the email distribution list are visible to recipients;
computer usable program code configured to identify an email message to be conveyed to at least the email distribution list, wherein the identified email message is to be conveyed to a plurality of recipients, wherein said plurality of recipients comprise a set of recipients associated with the email addresses contained in the email distribution list;
computer usable program code configured to create a plurality of recipient messages from the identified email message, one recipient message for each of the recipients; and
computer usable program code configured to apply the policy to each recipient email message to determine an extent that email addresses contained in the email distribution list are visible to that recipient.

11. The computer program product of claim 10, wherein different ones of the recipient email messages have different visibility regarding email addresses of members of the distribution list based upon the applied policy.

12. The computer program product of claim 10, wherein said policy is associated with a policy owner who possesses authorization privileges to establish and modify said policy.

13. The computer program product of claim 12, wherein a plurality of different policies exist, each having a policy specific owner, each being associated with a specific distribution list, and each being associated with a set of at least one recipients: said computer program product further comprising:
computer usable program code configured to determine the policy to be applied to each recipient email message based upon an identity of the distribution list and based upon an identity of the recipients.

14. The computer program product of claim 10, further comprising:
computer usable program code configured to identify a response to one of recipient email message, where said response is to be conveyed to at least the email distribution list, wherein the response is to be conveyed to a plurality of response recipients, wherein said plurality of response recipients comprise a set of recipients associated with the email addresses contained in the email distribution list; and
computer usable program code configured to create a plurality of response recipient messages from the response, one response recipient message for each of the response recipients; and
computer usable program code configured to apply the policy to each response recipient message to determine an extent that email addresses contained in the email distribution list are visible to that response recipient.

15. The computer program product of claim 10, wherein the policy applied to each response recipient message was originally established by a sender of the identified email message.

16. The computer program product of claim 10, wherein said policy is one of a plurality of established policies associated with email distribution list that is maintained within a network accessible data store: said computer program product further comprising:
computer usable program code configured to query the data store for the policy to apply to each recipient, wherein said policy is one associated with the sender of the identified email message.

17. The computer program product of claim 10, wherein the established policy is specified in a header of the identified email message, and wherein the header further comprises at least one visibility attribute.

18. The computer program product of claim 10, wherein responses to said recipient email messages that include the email distribution list are only conveyed to those email addresses contained in the email distribution list are visible within the recipient email message from which the response was generated.

19. A system for policy controlled email distribution lists comprising:
a policy server able to manage and apply policies associated with email distribution lists, wherein each policy specifies an extent that email addresses contained in the associated email distribution list are visible to recipients.

20. The system of claim 19, wherein said policy server applies policies to email messages before during their conveyance from a sending email client to a set of recipients specified within the email messages.
